(19) United States
(12) Patent Application Publication
(10) Pub. No.: US 2006/0200697 A1
(43) Pub. Date: Sep. 7, 2006

(54) Storage system, control method thereof, and program

(75) Inventor: Mikio Ito, Kawasaki (JP)

Correspondence Address: STAAS & HALSEY LLP;JIM LIVINGSTON, SUITE 700, 1201 NEW YORK AVENUE, N.W., WASHINGTON, DC, 20005, US

(73) Assignee: FUJITSU LIMITED, Kawasaki (JP)

(21) Appl. No.: 11/159,361

(22) Filed: Jun. 23, 2005

(30) Foreign Application Priority Data
Mar. 3, 2005 (JP) 2005-058784

(51) Int. Cl. G06F 11/00

(52) U.S. Cl. 714/6

(57) ABSTRACT

A RAID control unit forms a redundant configuration of RAID with respect to a physical device including a plurality of disk devices. A cache control unit processes data in page units corresponding to a stripe of the disk devices. A cache area placement unit, when it receives a write request from an upper-level device, places, in a cache memory, a cache area which is provided with a plurality of page areas and has the same size as the stripe area. When new data in the cache memory which is newer than the data in the physical device is to be written back to the storage device, a write-back processing unit generates new parity data by use of an unused area in the cache stripe area, and then writes the new data and the new parity to the corresponding storage devices.

This application is a priority based on prior application No. JP 2005-058784, filed Mar. 3, 2005, in Japan.

### BACKGROUND OF THE INVENTION

1. Field of the Invention

The present invention relates to a storage system, a control method thereof, and a program for processing, via a cache memory, input/output requests of an upper-level device with respect to storage devices, and, particularly, relates to a storage system, a control method thereof, and a program for writing back the latest data which has been updated in the cache memory to the storage devices.

2. Description of the Related Arts

Conventionally, in a RAID device for processing input/output requests from a host, in the manner of FIG. 1, a cache memory 102 is provided in a RAID device 100, and the input/output requests from a host to disk devices 104-1 to 104-4 are configured to be processed in the cache memory 102. Cache data of such RAID device 100 is managed in page units, and, in the manner of FIG. 2, a cache page 106 is managed such that, for example, 66,560 bytes serves as one page. The cache page 106 comprises user data in a plurality of block units serving as an access unit of host, one block of the user data is 512 bytes, 8-byte block check code (BCC) is added thereto at every 512 bytes, and a unit of 128 blocks of the 520-byte block is managed as one page, therefore, one page is 520×128=66,560 bytes. A cache management table called a cache bundle element CBE is prepared for managing the cache page 106. In the cache management table, a management record corresponding to every one page is present, and the management record retains, for example, a logical unit number LUN, a logical block address LBA, and a dirty data bitmap of dirty data in which one block is represented by one bit. One page of the cache management table has the same size as the size of a strip area of each of the disk devices constituting a RAID group. Herein, when RAID 5 is used as the redundant configuration of the RAID device 100, a cache area 108 for storing cache data is provided in the cache memory 102, and, separate from the cache area 108, a data buffer area 110 for storing old data and old parity and a parity buffer area 112 for storing new parity are provided as work areas for generating new parity in a write-back process. In a write-back process, for example, if a request for writing back new data (D2) new which is present as one-page data in the cache area 108 to the disk device 104-2 is generated, the write-back process is carried on after the data buffer area 110 and the parity buffer area 112 are reserved in the cache memory 102. Herein, since the new data (D2) is written to one of the disk devices, this write-back process is called small write. In the small write, old data (D2) old is readout from the disk device 104-2 and stored in the data buffer area 110, and old parity (P) old is read out from the disk device 104-4 and stored in the data buffer area 110 as well. Subsequently, an exclusive OR (XOR) 116 of the new data (D2) new, the old data (D2) old, and the old parity (P) old is calculated, thereby obtaining new parity (P), and it is stored in the parity buffer area 112. Lastly, the new data (D2) new and the new parity (P) new is written to the disk devices 104-2 and 104-4, respectively, and the process is terminated. The write back in a case in which new data is present in the manner corresponding to all of the strips of the disk devices 104-1 to 104-3 is called band-wide write; and in the band-wide write, new parity is calculated as the exclusive OR of all the data corresponding to the strip areas of the disk devices 104-1 to 104-3, and write to the disk devices 104-1 to 104-4 is performed so as to terminate the process. [Patent Document 1] Japanese Patent Application Laid-Open (kokai) No. H05-303528 [Patent Document 2] Japanese Patent Application Laid-Open (kokai) No. H08-115169 However, in such conventional cache control processes, the size of the data buffer area and the parity buffer area is not sufficiently reserved compared with that of the cache area, therefore, when shortage of the data buffer area and/or the parity buffer area occurs when write back is requested, the process is kept waiting until these areas have space, and the write-back process takes excessively long time. According to the present invention, there are provide a storage system, a control method thereof, and a program for eliminating the wait of the write-back process by reliably reserving storage areas of old data, old parity, and new parity without reserving a buffer area for work upon write back.

### SUMMARY OF THE INVENTION

The present invention provides a storage system. The storage system of the present invention is characterized by comprising a cache control unit for managing data in a cache memory in a page area unit, and processing an input/output request from an upper-level device to a storage device;

a RAID control unit for managing data in each of a plurality of the storage devices in a strip area unit having the same size as the page area and managing a plurality of strip areas having the same address collectively in a stripe area unit, generating parity from data in the plurality of strip areas, except for one strip area, included in the stripe area and storing the parity in the remaining one strip area, and forming a redundant configuration of RAID in which the storage device for storing the parity is changed for every address;

a cache area placement unit for, when receiving a write request from the upper-level device, placing in the cache memory a cache area comprising a plurality of page areas having the same size as the stripe area; and

a write-back processing unit for, when new data in the cache memory which is newer than the data in the storage device is to be written back to the storage device, generating new parity data by use of an unused area in the cache area, and then, writing the new data and the new parity to the corresponding storage devices.

Herein, if the new data is present in one of the plurality of page areas constituting the cache area, the write-back processing unit reads out old data and old parity from the storage devices corresponding to the new data by use of an unused page area as a work area, then, generates new parity from the new data, the old data, and the old parity, and writes the new data and the new parity to the corresponding storage devices.

If the new data is present in all of the page areas except for the parity-corresponding area of the plurality of page areas constituting the cache area, the write-back processing unit generates new parity from the plurality of new data by use of an unused page area as a work area, and writes the new data and the new parity to the corresponding storage devices.

If the new data is present in all of the page areas except for the parity-corresponding area of the plurality of page areas constituting the cache area and space is present in a part of the new data in the page areas, the write-back processing unit reads out old data from the storage device corresponding to the part of the space in the page areas and stores it, then, generates new parity from the plurality of new data by use of an unused page area as a work area, and writes the new data and the new parity to the corresponding storage devices. The cache area placement unit releases, when write by the write-back processing unit is completed, the corresponding cache area.

The present invention provides a control method of a storage system. The control method of a storage system according to the present invention comprises

a cache control step of managing data in a cache memory in a page area unit, and processing an input/output request from an upper-level device to a storage device;

a RAID control step of managing data in each of a plurality of the storage devices in a strip area unit having the same size as the page area and managing a plurality of strip areas having the same address collectively in a stripe area unit, generating parity from data in the plurality of strip areas, except for one strip area, included in the stripe area and storing the parity in the remaining one strip area, and forming a redundant configuration of RAID 5 in which the storage device for storing the parity is changed for every address;

a cache area placement step of, when receiving a write request from the upper-level device, placing in the cache memory a cache area comprising a plurality of page areas having the same size as the stripe area; and

a write-back processing step of, when new data in the cache memory which is newer than the data in the storage device is to be written back to the storage device, generating new parity data by use of an unused area in the cache area, and then, writing the new data and the new parity to the corresponding storage devices.

The present invention provides a program to be executed by a computer of a storage system. The program of the present invention is characterized by causing a computer of a storage system to execute

a cache control step of managing data in a cache memory in a page area unit, and processing an input/output request from an upper-level device to a storage device;

a RAID control step of managing data in each of a plurality of the storage devices in a strip area unit having the same size as the page area and managing a plurality of strip areas having the same address collectively in a stripe area unit, generating parity from data in the plurality of strip areas, except for one strip area, included in the stripe area and storing the parity in the remaining one strip area, and forming a redundant configuration of RAID 5 in which the storage device for storing the parity is changed for every address;

a cache area placement step of, when receiving a write request from the upper-level device, placing in the cache memory a cache area comprising a plurality of page areas having the same size as the stripe area; and

a write-back processing step of, when new data in the cache memory which is newer than the data in the storage device is to be written back to the storage device, generating new parity data by use of an unused area in the cache area, and then, writing the new data and the new parity to the corresponding storage devices.

Note that the details of the control method of a storage system and the program in the present invention are basically same as the case of the storage system of the present invention.

According to the present invention, regarding the RAID 5, when write is requested by a host, a cache area corresponding to one stripe which is one group of strip areas of a plurality of disk devices is placed and reserved in a cache memory, and the cache area is managed in the same manner as user data. Accordingly, in write back, an unused page area, which has been placed and is not that of new data, is used as a work area for storing old data, old parity, and new parity. As a result, in write back, the buffer areas for work which are separate from the cache area do not have to be newly provided, and the delay in write-back processing time caused by shortage of the buffer areas can be eliminated. The above and other objects, features, and advantages of the present invention will become more apparent from the following detailed description with reference to the drawings.

### BRIEF DESCRIPTION OF THE DRAWINGS

FIG. 1 is an explanatory diagram of a conventional write-back process;

FIG. 2 is an explanatory diagram of a cache page in a conventional system;

FIGS. 3A and 3B are block diagrams of a hardware configuration of a RAID device to which the present invention is applied;

FIG. 4 is a block diagram of another hardware configuration of the RAID device to which the present invention is applied;

FIG. 5 is a block diagram of a functional configuration of the RAID device according to the present invention;

FIG. 6 is an explanatory diagram of strip areas and a stripe area of cache pages and disk devices;

FIG. 7 is a flow chart of a cache write process in the present invention;

FIGS. 8A to 8D are explanatory diagrams of cache placement for write-requested data of a size less than one page;

FIGS. 9A to 9D are explanatory diagrams of cache placement of write-requested data of a one-page size;

FIGS. 10A to 10D are explanatory diagrams of cache placement of write-requested data of a three-page size;

FIGS. 11A to 11D are explanatory diagrams of cache placement of write-requested data of a four-page size;

FIG. 12 is an explanatory diagram of a write-back process of small write in the present invention;

FIG. 13 is an explanatory diagram of a write-back process of band-wide write in the present invention;

FIG. 14 is an explanatory diagram of a write-back process of read wide write in the present invention;

FIG. 15 is a flow chart of a write-back process of RAID 5 in the present invention;

FIG. 16 is a flow chart of a write-back process of the small write in the present invention;

FIG. 17 is a flow chart of a write-back process of the band-wide write in the present invention; and

FIG. 18 is a flow chart of a write-back process of the read band-wide write in the present invention.

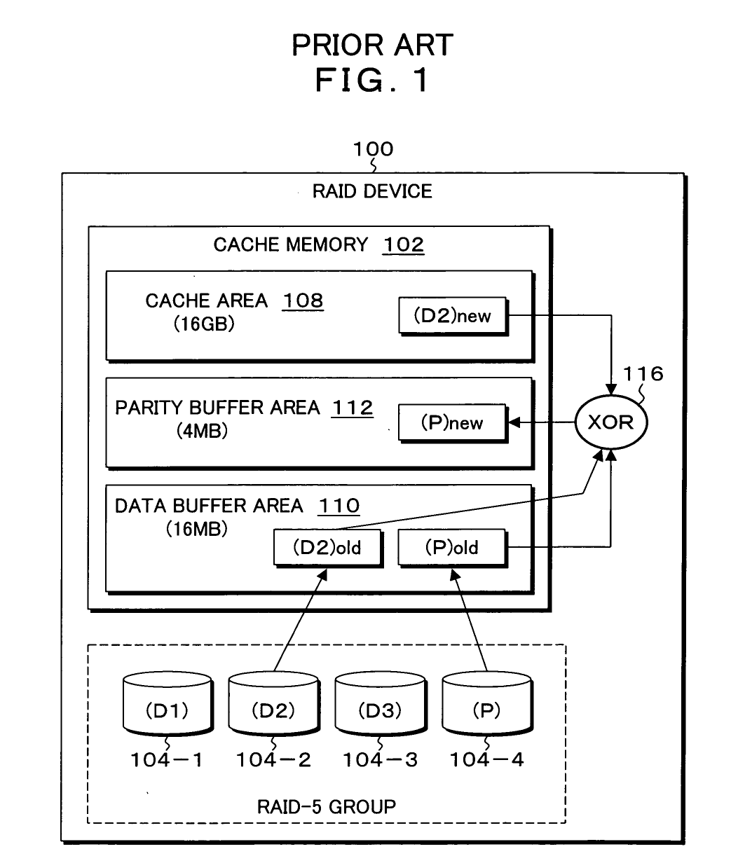

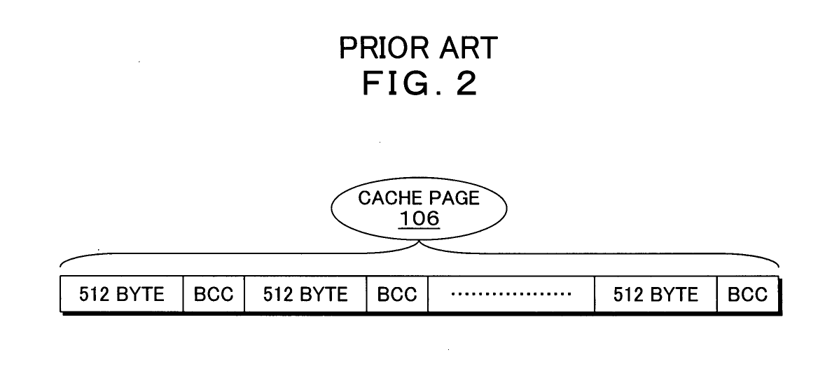

### DETAILED DESCRIPTION OF THE PREFERRED EMBODIMENTS

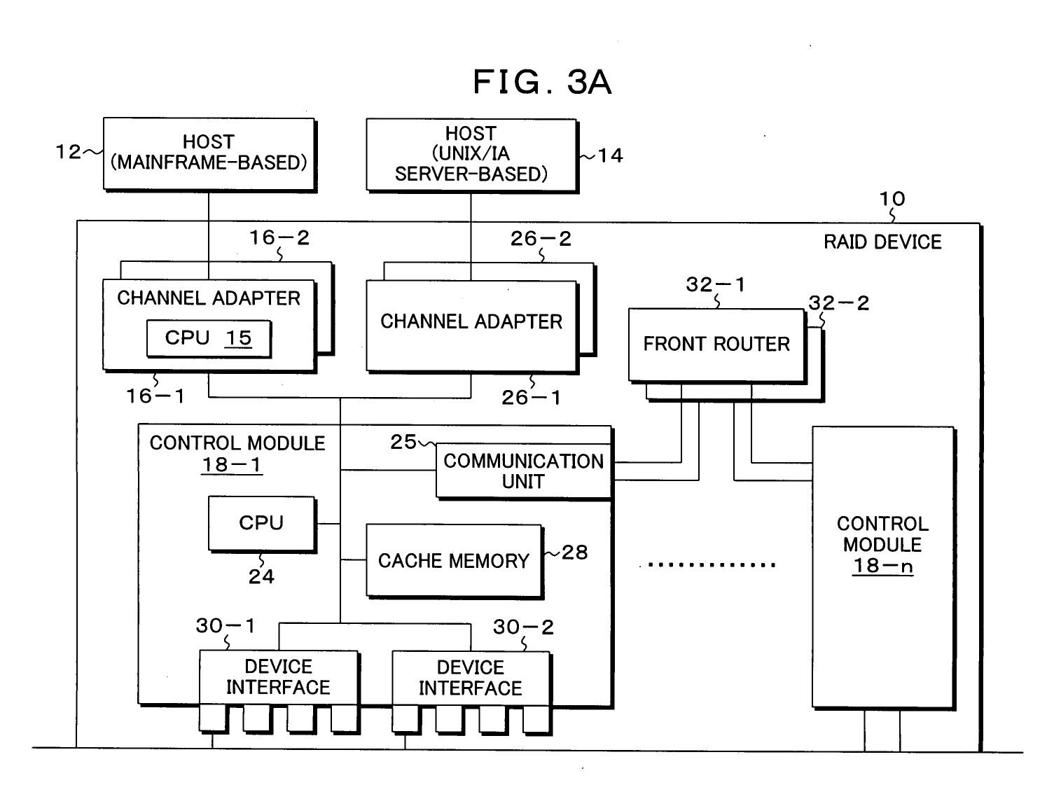

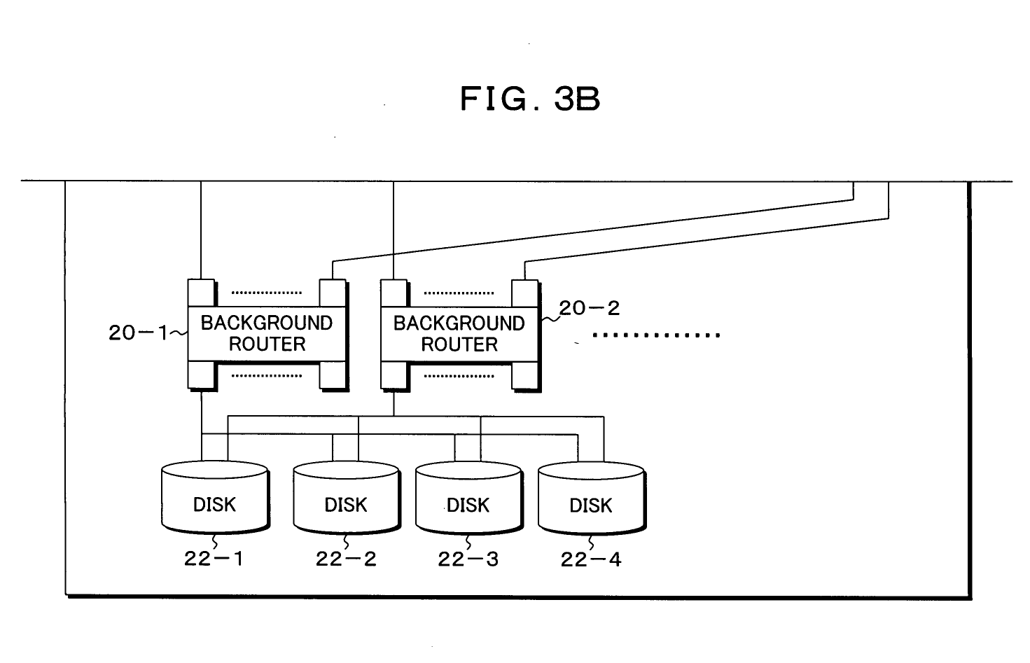

FIGS. 3A and 3B are block diagrams of a hardware configuration of a RAID device to which the present invention is applied, wherein a large-scale constitution of the device is employed as an example. In FIGS. 3A and 3B, a frame-based host 12 and a UNIX (R)/IA server-based host 14 are provided with respect to a RAID device 10. In the RAID device 10 provided are channel adapters 16-1 and 16-2 provided with CPUs 15, control modules 18-1 to 18-n, background routers 20-1 and 20-2, disk devices 22-1 to 22-4 such as hard disk drives which serve as storage devices and form a redundant configuration of RAID 5, and front routers 32-1 and 32-2. In a maximum constitution, eight control modules can be mounted on the RAID device 10. The channel adapters 16-1 and 16-2 are provided with the CPUs 15, and connect the framework-based host 12 to the control module 18-1. In addition, channel adapters 26-1 and 26-2 connect the UNIX (R)/IA server-based host 14 to the control module 18-1. The channel adapters 16-1 and 16-2 and the channel adapters 26-1 and 26-2 are connected to other control modules 18-2 (unillustrated) to 18-n, through a communication unit 25 provided in the control module 18-1, and then, via the front routers 32-land 32-2. In each of the control modules 18-1 to 18-n, as representatively shown in the control module 18-1, a CPU 24, the communication unit 25, a cache memory 28, and device interfaces 30-1 and 30-2 are provided. The CPU 24 is provided with an input/output processing function for processing an input/output request corresponding to a write command or a read command from the host 12 or the host 14 in the cache memory 28 so as to respond to it, in addition, through program control, performs control and management of the cache memory 28, write-back of cache data to the disk devices 22-1 to 22-4 via the cache memory 28 and then via the background routers 20-1 and 20-2, staging of disk data from the disk devices 22-1 to 22-4, etc. The front routers 32-1 and 32-2 connect other control modules 18-2 (unillustrated) to 18-n to the control module 18-1, thereby multiplexing the control. Each of the control modules 18-1 to 18-n is connected to the background routers 20-1 and 20-2, and performs data input/output processes according to RAID control performed by the CPU 24 in the control module side.

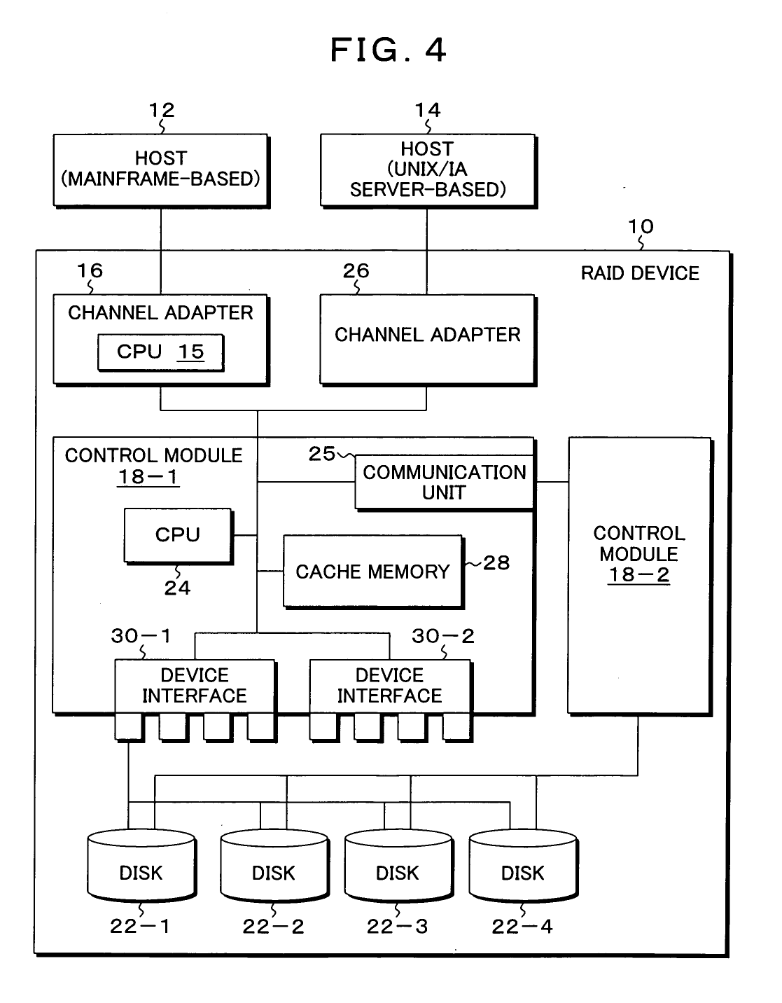

FIG. 4 is a block diagram of another hardware configuration of the RAID device to which the present invention is applied, wherein a case of a small size or a medium size device having a small scale compared with the large-scale device of FIGS. 3A and 3B are employed as examples. In FIG. 4, the RAID device 10 is provided with a channel adapter 16 which is provided with the CPU 15, the control modules 18-1 and 18-2 having a duplex configuration, and the disk devices 22-1 to 22-4 forming a redundant configuration of at least RAID 5. In the control module 18-1 or 18-2, as representatively shown in the control module 18-1, the CPU 24, the communication unit 25, the cache memory 28, and the device interfaces 30-1 and 30-2 are provided. The UNIX (R)/IA server-based host 14 is connected to the control module 18-1 via a channel adapter 26. The RAID device 10 of FIG. 4 corresponding to a small size or a medium size has a small-scale configuration in which the background routers 20-1 and 20-2 and the front routers 32-1 and 32-2 are removed from the RAID device 10 of FIGS. 3A and 3B. Except for this, the configuration is basically same as that of FIGS. 3A and 3B.

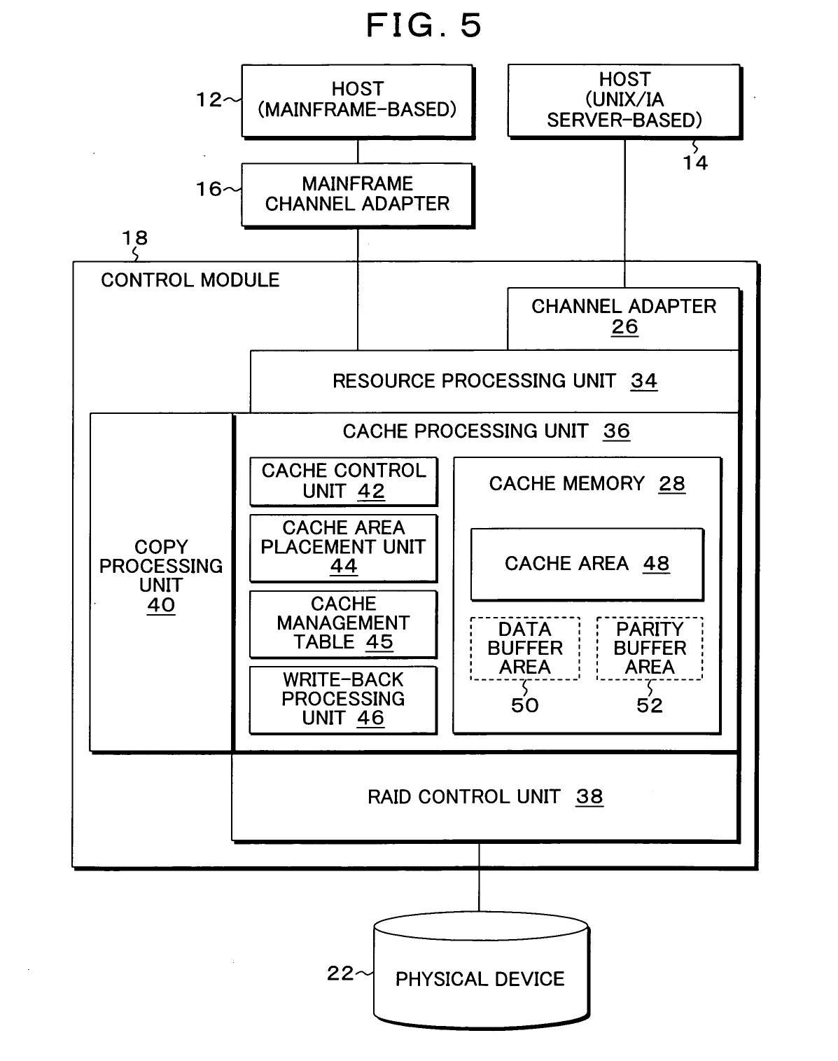

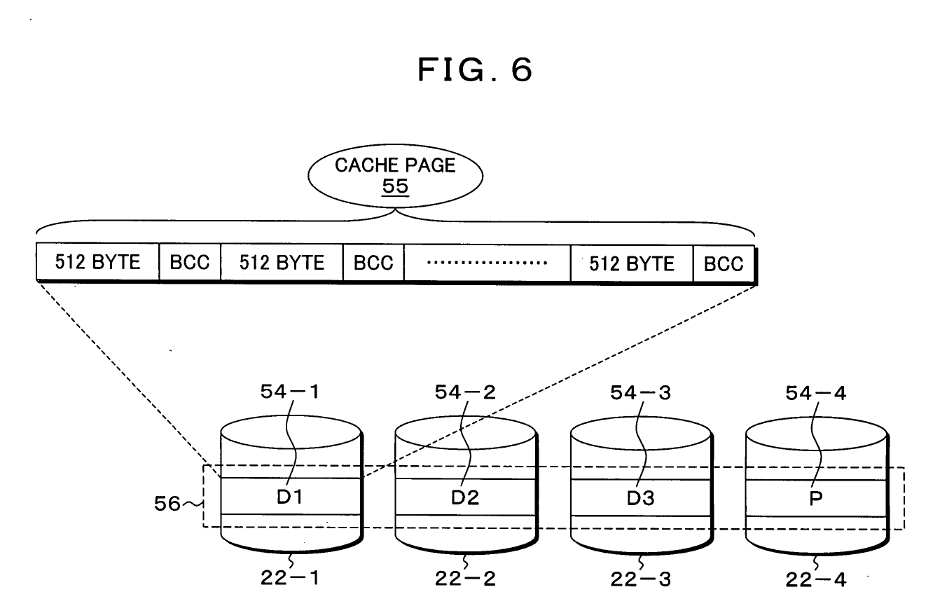

FIG. 5 is a block diagram of a functional configuration of the RAID device according to the present invention. In FIG. 5, functions of the RAID device 10 are realized by program control performed by the CPU 24 which is provided in the control module 18, thereby forming, as shown in the control module 18, a resource processing unit 34, a cache processing unit 36, a RAID control unit 38, and a copy processing unit 40. In the cache processing unit 36, a cache control unit 42, a cache area placement unit 44, a cache management table 45, a write-back processing unit 46, and a cache memory 28 are provided. In the cache memory 28 provided are a cache area 48 which is placed when a write request from the host 12 or the host 14 is received so as to write data therein, a data buffer area 50 which is placed in a write-back process for writing cache data which is in the cache area 48 to the disk device which has a RAID configuration and is represented by a physical device 22, and a parity buffer area 52. The cache control unit 42 manages the data in the cache memory 28 in page area units, and processes input/output requests of the host 12 or the host 14 with respect to the physical device 22 which forms a RAID group by a plurality of disk devices. That is, the cache control unit 42 forms, as shown in FIG. 6, one page as a cache page 55 by 66,560 bytes including 128 blocks of 520-byte block data, which is an access unit from the host side, comprising 512-byte user data and 8-byte BCC. Such cache pages 55 in the cache memory 28 are recorded and managed in the cache management table 45 in page units, and the decode in the cache management table 45 comprises, for example, a logical unit number (LUN), and a logical block address (LBA), and a dirty data bitmap (128 bit) in which blocks comprising new data are represented by bits. Referring again to FIG. 5, the RAID control unit 38 performs RAID control according to a redundant configuration of RAID 5 in the present invention on the physical device 22 constituting a RAID group by a plurality of disk devices. That is, the RAID control unit 38, as shown in the disk devices 22-1 to 22-4 of FIG. 6, manages the data in the disk devices 22-1 to 22-4 as strip areas 54-1, 54-2, 54-3, and 54-4, respectively, each of which having the same size as the cache page 55 which is in the cache memory 28, and manages the plurality of strip areas 54-1 to 54-4 having the same address collectively as a stripe area 56. In a case of a redundant configuration of RAID 5, for example, in a case of the stripe area 56, data D1, D2, and D3 are stored in the strip areas 54-1 to 54-3 of the disk devices 22-1 to 22-3, respectively, and parity P is stored in the strip area 54-4 of the remaining disk device 22-4. In the case of a redundant configuration of RAID 5, the position of the disk which stores the parity P changes every time the address of the stripe area 56 is changed. Referring again to FIG. 5, when a write request from the host 12 or the host 14 is received, the cache area placement unit 44 provided in the cache processing unit 36 places, in the cache memory 28, a plurality of page areas having the same size as the stripe area 56 which is provided over the disk devices 22-1 to 22-4 shown in FIG. 6, in this example, places the cache area 48 comprising four pages of page areas. In addition, when new data in the cache area 48 in the cache memory 28 which is newer than the data in the disk devices is to be written back to the disk devices, the write-back processing unit 46 generates new parity by use of an unused page area in the cache area 48 which has been placed to have the same size as the stripe area, and then, writes the new data and the new parity to corresponding disk devices. As described above, in the present invention, when a write request is received from the host 12 or the host 14, a cache memory area corresponding to one stripe including parity is simultaneously allocated (placed) and managed in the same manner as user data. For example, in the manner of FIG. 6, when there are four disk devices 22-1 to 22-4 and four strip areas 54-1 to 54-4 in the RAID group, in response to a write request from a host, a cache area corresponding to one stripe comprising four strip areas, i.e., a cache area corresponding to four pages is simultaneously allocated, and write-requested data is written to a part of or all of the pages, except for the unused page for parity, of the cache area corresponding to three pages, thereby performing management similar to that of user data.

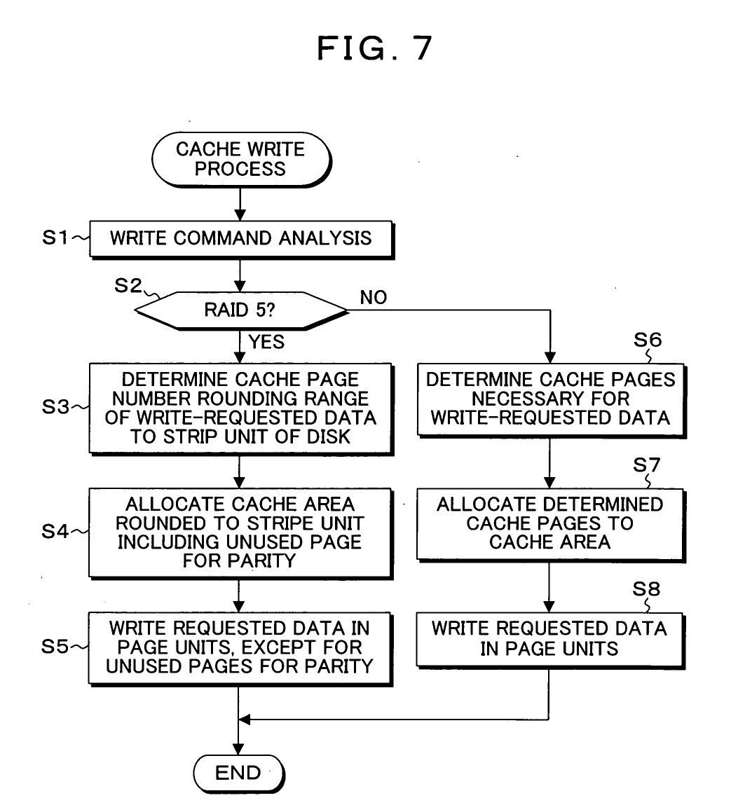

FIG. 7 is a flow chart of a cache write process in the present invention. In FIG. 7, in the cache write process, in response to a write request from a host, the write command is analyzed in a step S1, and whether or not it is RAID 5 is checked in a step S2. If it is RAID 5, a process according to the present invention is performed from a step S3. In the step S3, the number of cache pages rounding the range of the write-requested data to strip units of the disk devices is determined. That is, if the write-requested data is less than one page, the number of the cache pages is set to one. If the size of the write-requested data is 1.5 pages, it is rounded thereby setting two pages of the cache pages. Next, in a step S4, the cache area rounded to a stripe unit including an unused page(s) for parity is allocated. In the manner of FIG. 6, when the stripe area 56 comprises four strip areas 54-1 to 54-4, i.e., four pages joining four cache pages 55; and if the number of cache pages determined in the step S3 is equal to or less than three, a cache area corresponding to one stripe is allocated, and, for example, if it is four pages, a cache area corresponding to two stripes is allocated. Subsequently, in a step S5, except for the unused page(s) for parity, the requested data is written in page units to the allocated cache area from the top page thereof. As a matter of course, if the requested data is less than one page, it is stored from the top position of the top page, and, in this case, the rear side of the top page becomes an unused area. On the other hand, if RAID other than RAID 5, for example, RAID 3 or RAID 4 is determined in the step S2, after the process proceeds to a step S6 wherein cache pages necessary for the write-requested data are determined, the determined cache pages are allocated in the cache area in a step S7, and the requested data is written in page units in a step S8. In other words, in response to write requests to that other than RAID 5, cache management is performed in page units.

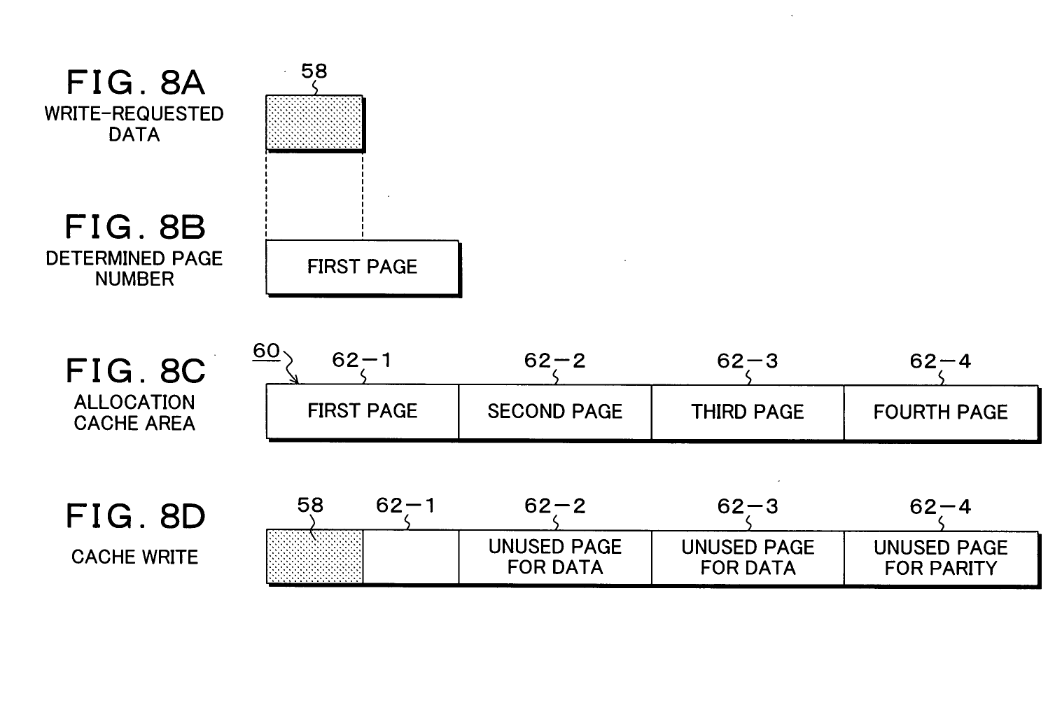

FIGS. 8A to 8D are explanatory diagrams of cache placement on RAID 5 for write-requested data of a size less than one page. FIG. 8A is the write-requested data having a size less than 66,560 bytes which is the capacity of one cache page. In this case, in the manner of FIG. 8B, the write-requested data is rounded, thereby determining one page as the page number. Next, in the manner of FIG. 8C, with respect to one page which is the determined page number, a cache area corresponding to one stripe which is provided over a plurality of disk devices forming a RAID 5 group, i.e., corresponding to four pages is allocated. This allocated cache area 60 comprises a first page 62-1, a second page 62-2, a third page 62-3, and a fourth page 62-4. Subsequently, cache write of the write-requested data 58 to the first page 62-1 at the top is performed in the manner of FIG. 8D. In this cache written state, the write-requested data 58 is stored in the front side of the first page 62-1 at the top, and the rear side is an unused area. The second page 62-2 and the third page 62-3 are unused pages for data, and the last fourth page 62-4 is an unused page for parity. As a matter of course, if the address of the stripe changes, the position of the unused page for parity changes to another page position.

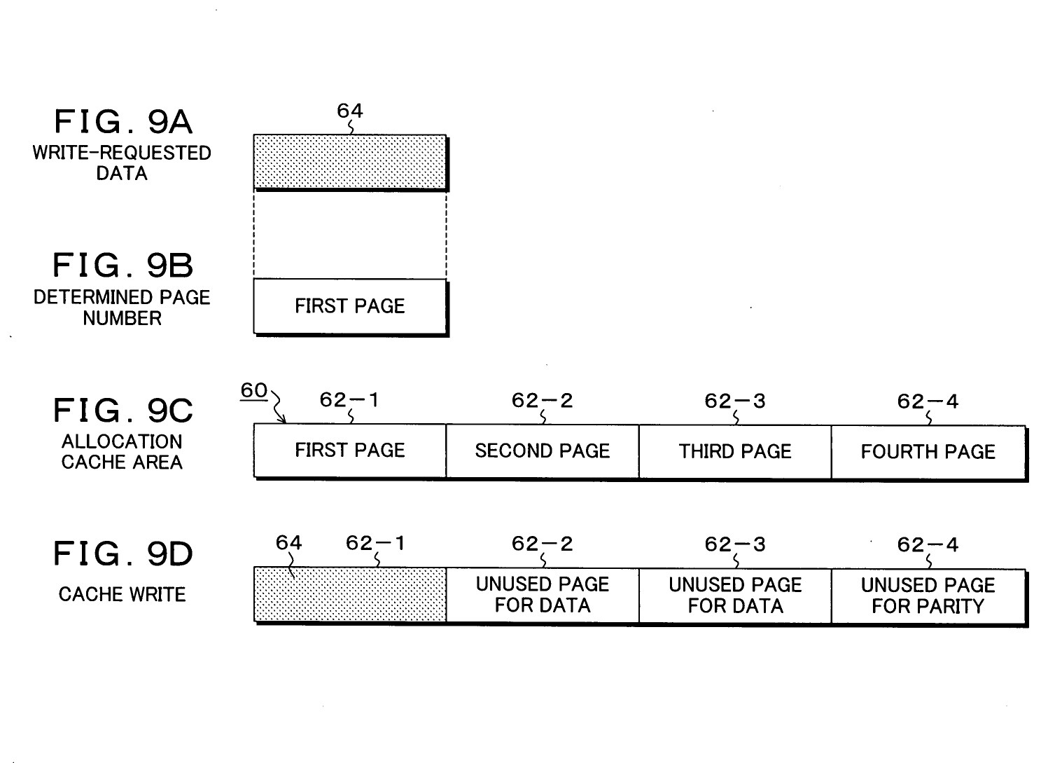

FIGS. 9A to 9D are explanatory diagrams of a cache placement process of write-requested data of a one-page size. The write-requested data 64 of FIG. 9A is 66,560 bytes which is corresponding to one page of cache, and therefore, in the manner of FIG. 9B, one page is determined as the page number. Subsequently, in the manner of FIG. 9C, corresponding to one page which is the determined page number, the cache area 60 comprising four pages corresponding to one stripe is allocated. After this allocation, with respect to the cache area 60, in the manner of FIG. 9D, the write-requested data 64 corresponding to one page is stored in the first page 62-1.

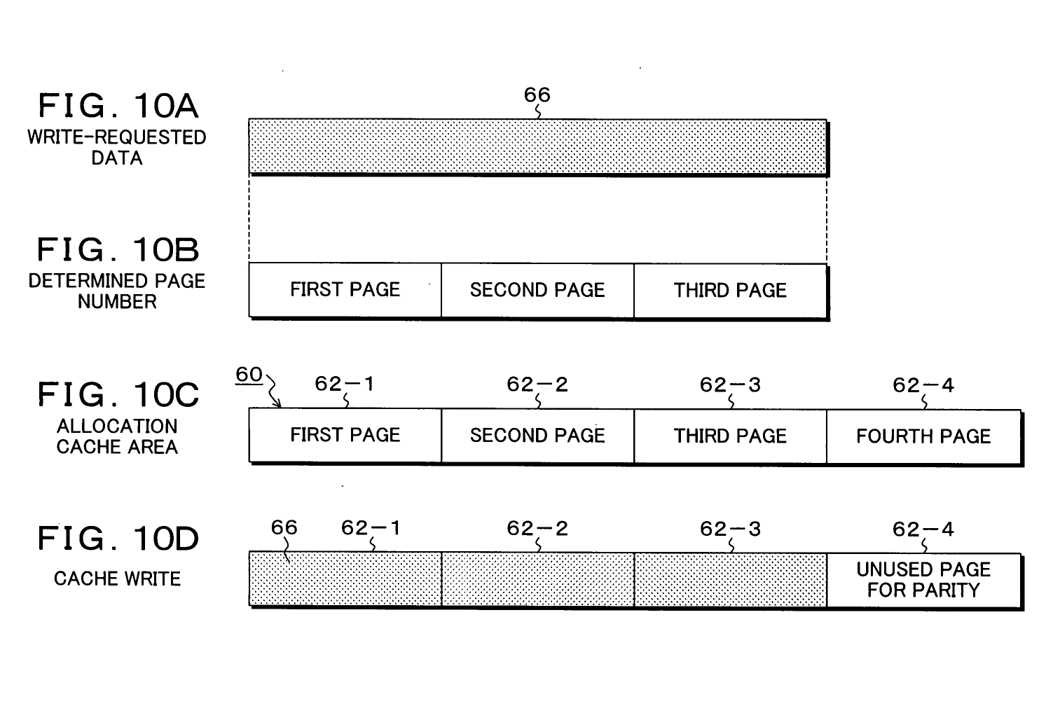

FIGS. 10A to 10D are explanatory diagrams of cache placement of write-requested of a three-page size. FIG. 10A is the write-requested data 66, and has a size corresponding to three pages. Therefore, as the determined page number of FIG. 10B, three pages, i.e., a first page, a second page, and a third page are determined. Subsequently, in FIG. 10C, according to the three pages which are the determined page number, the cache area 60 corresponding to one stripe is allocated. After the allocation, in the manner of FIG. 10D, the write-requested data 66 having a size corresponding to three pages is subjected to page division, so as to store it sequentially in the first page 62-1, the second page 62-2, and the third page 62-3. In this case, an unused page is only the unused page for parity of the last fourth page 62-4.

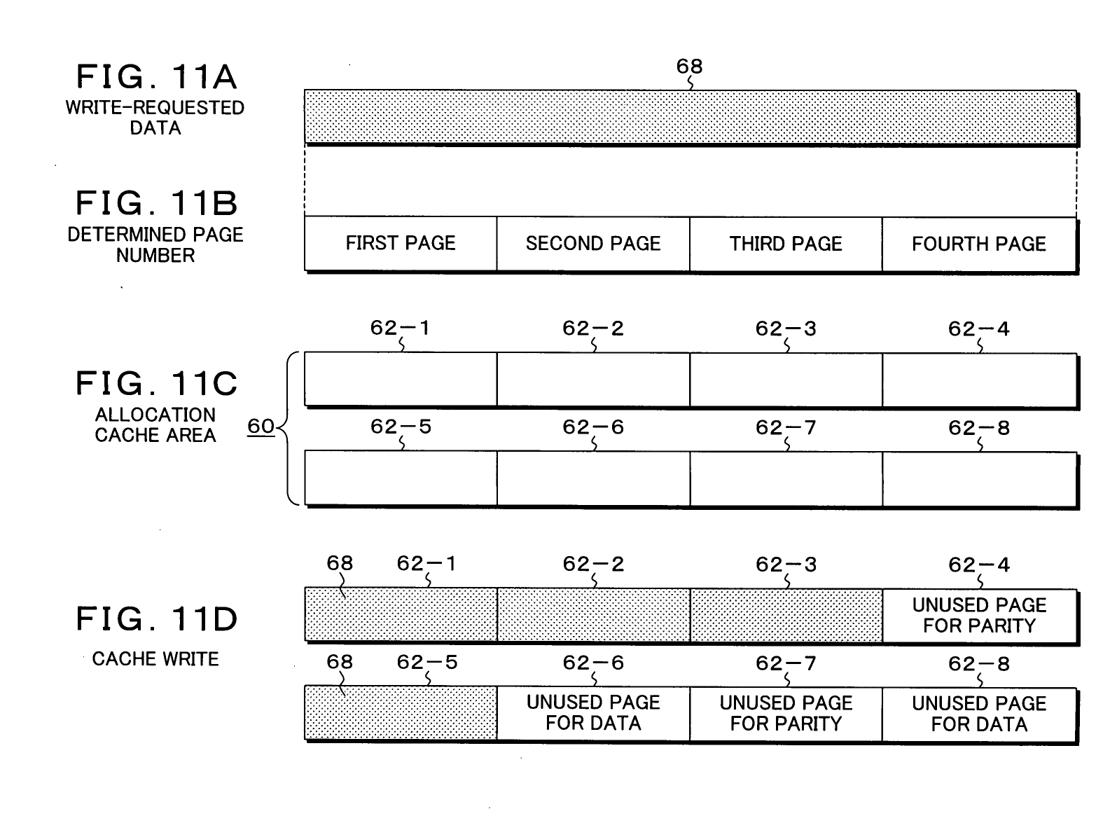

FIGS. 11A to 11D are explanatory diagrams of cache placement of write-requested data of the four-page size. FIG. 11A is the write-requested data having the size of four pages for which four pages are determined as the page number in the manner of FIG. 11B. Next, in the manner of FIG. 11C, it is taken into consideration that one page of a parity page is to be added to the data of the four pages which are the determined page number, and the cache area 60 in which a first page 62-1 to an eighth page 62-8 corresponding to eight pages, i.e., corresponding to two stripes are divided into two is allocated. After this allocation, in the manner of FIG. 11D, a part of the write-requested data 68 corresponding to three pages from the top thereof is stored in the first page 62-1 to the third page 62-3 which are the three pages from the top of the first stripe area, and the fourth page 62-4 is left to be an unused page for parity. The write-requested data corresponding to the fourth page is stored in the first page 62-5 of the other stripe. In this case, each of the remaining three pages, i.e., the second page 62-6, the third page 62-7, and the fourth page 62-8 is set to be an unused page for data or an unused page for parity. Although the unused page for parity in the top stripe is the fourth page 62-4, in the subsequent stripe, the third page 62-7 serves as an unused page for parity, thereby changing the position of parity according to the address of the stripe areas. As described above, according to a write request from the host 12 or the host 14, the data stored in the cache area 48 which is reserved in a stripe area unit in the cache memory 28 in FIG. 5, i.e., dirty data which is the data newer than the data stored in the disk devices of the RAID group in the physical device 22 side, i.e., new data is subjected to a write-backprocess in which it is written to the plurality of disk devices of the RAID group constituting the physical device 22, according to, for example, LRU control, in the cache control unit 42.

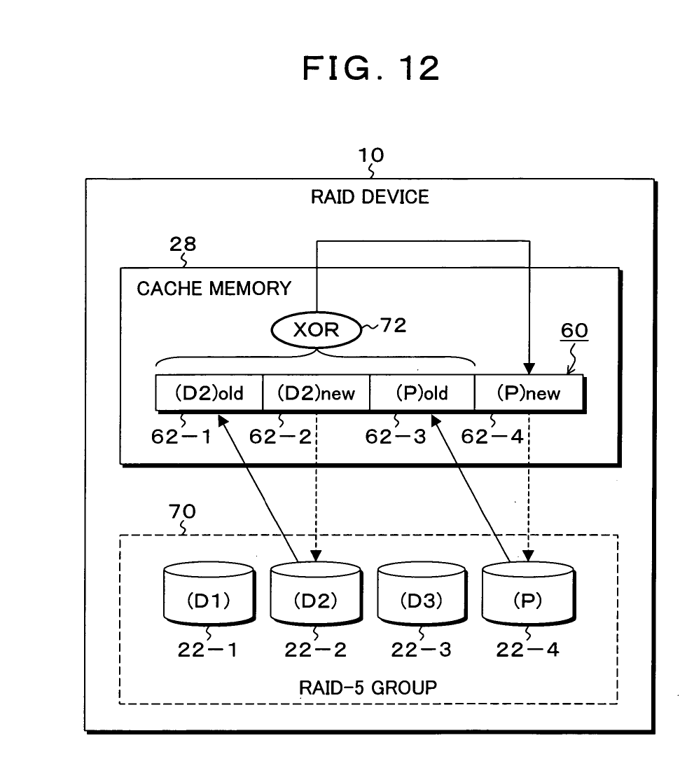

FIG. 12 is an explanatory diagram of a write-back process of small write in the present invention. The small write is the case in which new data is present in a part of a plurality of pages constituting the cache area 60 corresponding to one stripe. In FIG. 12, the cache area 60 which has been allocated in accordance with a write command is placed in the cache memory 28 of the RAID device 10, and the cache area 60 is the area corresponding to one stripe comprising the first page 62-1, the second page 62-2, the third page 62-3, and the fourth page 62-4. In such cache area 60, when the write-back process is to be started, for example, new data (D2) new is present only in the second page 62-2, and, except for this, the first page 62-1, the third page 62-3, and the fourth page 62-4 are left to be unused page areas. When the new data (D2) new which is present only in the second page 62-2 is to be written back to a RAID 5 group 70, the first page 62-1, the third page 62-3, and the fourth page 62-4, which are unused page areas, are used as work areas. Therefore, in the write-back process, unlike conventional manners, a data buffer area and a parity buffer area are not required to be newly allocated in the cache memory 28. When the new data (D2) new in the second page 62-2 is to be written back, first, old data (D2) old in the corresponding disk device 22-2 is read out and stored in the first page 62-1. In addition, old parity (P) old is read out from the disk device 22-4 and stored in the third page 62-3. Next, an exclusive OR (XOR) of the old data (D2) old, the new data (D2) new, and the old parity (P) old reserved in the cache area 60 is operated by an operation unit 72, thereby obtaining new parity (P) new, and it is stored in the fourth page 62-4 which is an unused page area. Then, the new data (D2) new and the new parity (P) new are stored in the corresponding disk devices 22-2 and 22-4 in the RAID 5 group 70.

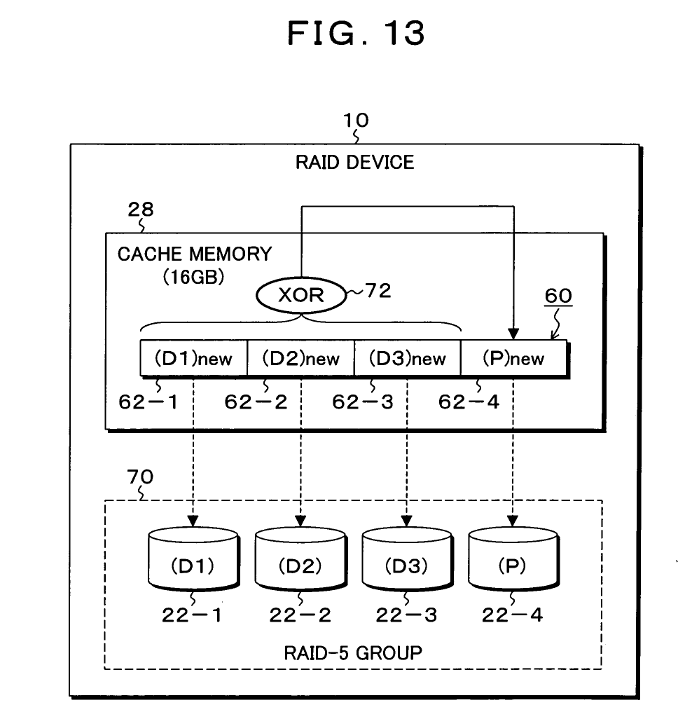

FIG. 13 is an explanatory diagram of a write-back process of band-wide write in the present invention. In a case of the write-back process of band-wide write, as shown in the cache memory 28 provided in the RAID device of FIG. 12, except for, for example, the fourth page 62-4 serving as a parity page in the cache area 60 which has been allocated in accordance with a write request from a host, new data is present in all the other pages. That is, new data (D1) new is present in the first page 62-1, new data (D2) new is present in the second page 62-2, and new data (D3) new is present in the third page 62-3. In such case, read from the RAID 5 group 70 is not required, an exclusive OR (XOR) of the pages, except for the parity page, of the cache area 60 which is to be subjected to write back, i.e., the new data (D1) new, (D2) new, and (D3) new present in the first page 62-1, the second page 62-2, and the third page 62-3 is calculated by the operation unit 72, thereby obtaining new parity (P) new, and it is stored in the fourth page 62-4 which is an unused page. Then, the new data (D1) new, (D2) new, and (D3) new, and the new parity (P) new in the cache area 60 is written to the respective disk devices 22-1 to 22-4 constituting the RAID 5 group 70.

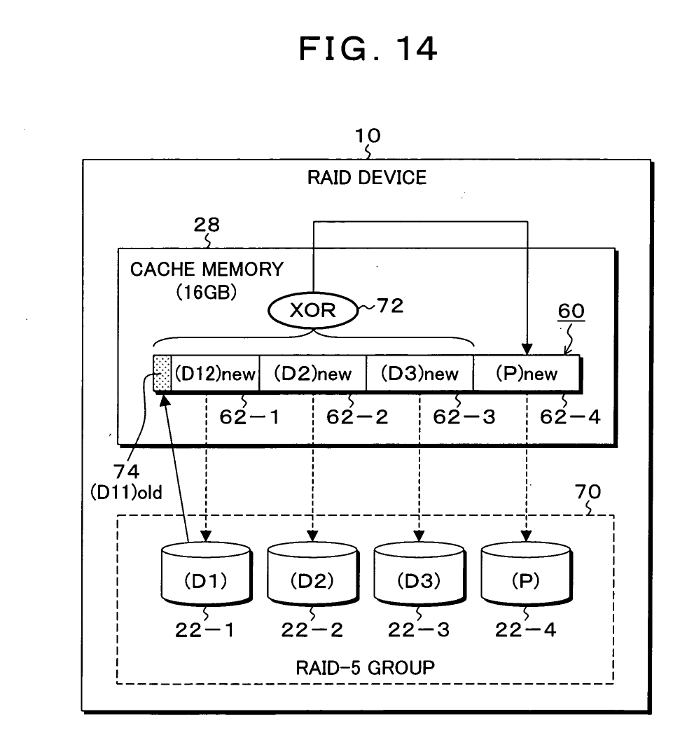

FIG. 14 is an explanatory diagram of a write-back process of read band-wide write in the present invention. In a case of the write-back process of read band-wide write, as shown in the first page 62-1 of the cache area 60 which has been allocated in the cache memory 28 of the RAID device 10 of FIG. 14, new data (D12) new is partially present, and an unused area 74 is provided. In this case, after data is read out from the corresponding disk device 22-1 and stored as old data (D11) old, an exclusive OR of all data of the first page 62-1, the second page 62-2, the third page 62-3 is calculated by the operation unit 72, thereby obtaining new parity (P) new, and it is stored in the fourth page 62-4 which is an unused page. Then, the data corresponding to one page joining the old data (D11) old and the new data (D12) new of the first page 62-1 is written to the corresponding disk device 22-1, and, regarding the second page 62-2, the third page 62-3, and the fourth page 62-4, the new data (D2) new, the new data (D3) new, and the newparity (P) new is written to the corresponding disk devices 22-2, 22-3, and 22-4, respectively. As described above, in any of the write-back processes of the small write of FIG. 12, the band-wide write of FIG. 13, and the read band-wide write of FIG. 14, by utilizing an unused page(s) in the cache area 60 which is to be subjected to write back, old data can be read out from the disk devices, and the calculated new parity can be stored. Therefore, a data buffer area and a parity buffer area are not required to be reserved in the cache memory 28 in the write-back processes, and there reliably solved the problem that write-back processes take excessively long time, since, in conventional write-back processes, shortage of the unused area in the cache memory occurs and the data buffer area and the parity buffer area cannot be reserved.

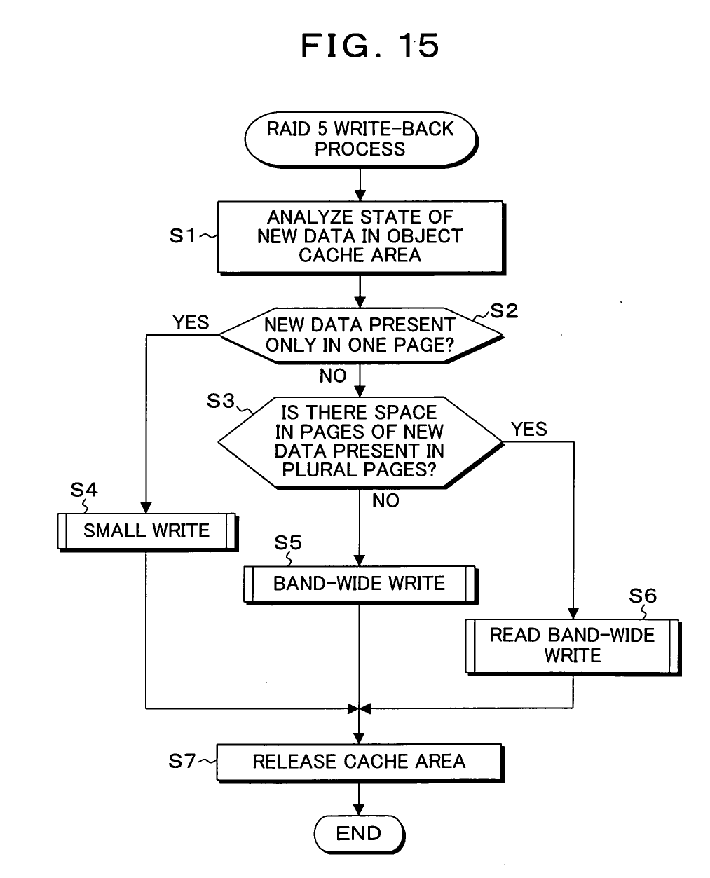

FIG. 15 is a flow chart of a write-back process of RAID 5 according to the present invention. In the write-back process, the state of new data in the object cache area is analyzed in a step S1, and whether or not the new data is present only in one page is checked in a step S2. If it is only in one page, i.e., equal to or less than one page, the write-back process of small write is executed in a step S4. If the new data is determined to be present in a plurality of pages in a step S2, the process proceeds to a step S3, wherein whether or not there is space in the pages of the new data which is present in the plurality of pages is checked. If there is no space, the write-back process of band-wide write is executed in a step S5. If there is space in the pages, the process proceeds to a step S6, wherein the write-back process of read band-wide write is executed. When the write back process of the step S4, the step S5, or the step S6 is completed, the cache area serving as the object is released in a step S7.

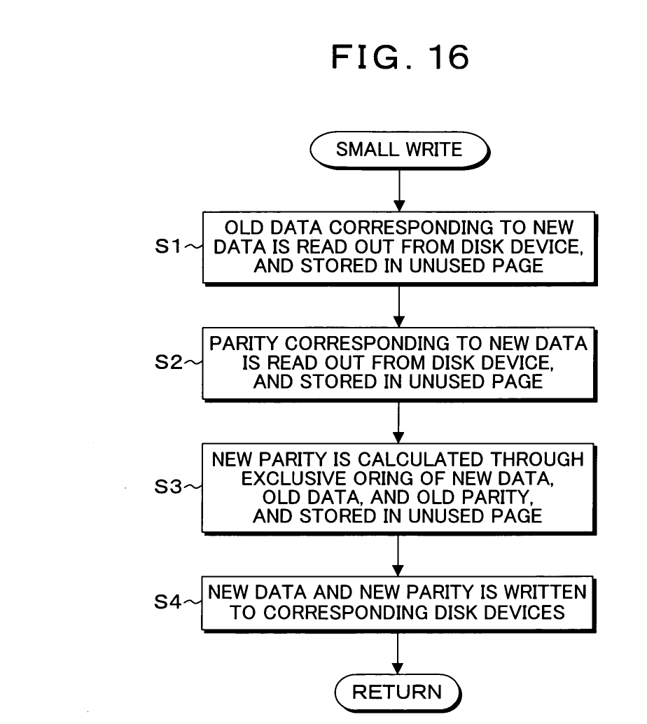

FIG. 16 is a flow chart of the small write of the step S4 of FIG. 15. In the small write, the old data corresponding to the new data is read out from a disk device and stored in an unused page in a step S1, and, then, the parity corresponding to the new data is read out from a disk device and stored in an unused page in a step S2. Then, in a step S3, new parity is calculated through exclusive ORing of the new data, the old data, and the old parity, and stored in an unused page. Lastly, in a step S4, the new data and the new parity is written to the corresponding disk devices.

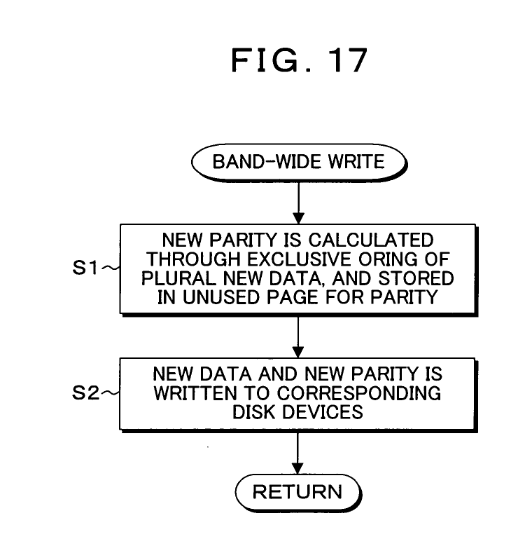

FIG. 17 is a flow chart of the band-wide write of the step S5 of FIG. 15. In the band-wide write, in a step S1, new parity is calculated through exclusive ORing of the plurality of new data, and stored in an unused page for parity. Then, in a step S2, the new data and the new parity is written to the corresponding disk devices.

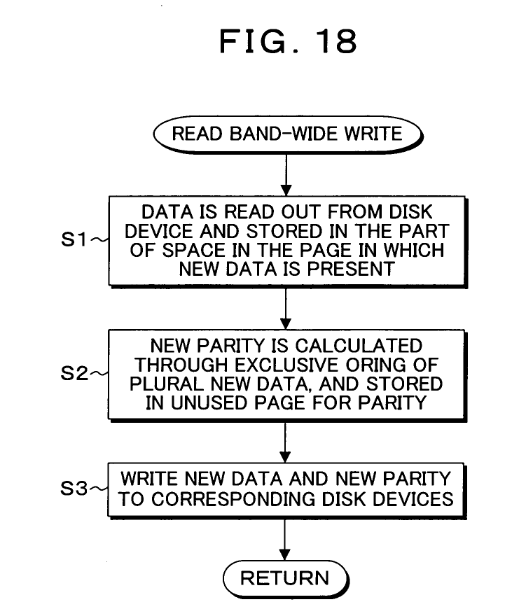

FIG. 18 is a flow chart of the read band-wide write of the step S6 of FIG. 15. In the read band-wide write, after data is read out from a disk device and stored in the unused part in the page(s) in which the new data is present in a step S1, new parity is calculated through exclusive ORing of the plurality of new data, and stored in an unused page for parity in a step S2, and, lastly, the new data and the new parity is written to the corresponding disk devices in a step S3. Moreover, the present invention provides a program to be executed in the CPU 24 of the RAID device, and is capable of realizing the program in a procedure according to the flow charts of FIG. 7, FIG. 15, FIG. 16, and FIG. 17. The present invention includes appropriate modifications that do not impair the objects and advantages thereof, and is not limited by the numerical values described in the above described embodiments.

What is claimed is:

1. A storage system comprising
a cache control unit for managing data in a cache memory in a page area unit, and processing an input/output request from an upper-level device to a storage device;
a RAID control unit for managing data in each of a plurality of the storage devices in a strip area unit having the same size as the page area and managing a plurality of strip areas having the same address collectively in a stripe area unit, generating parity from data in the plurality of strip areas, except for one strip area, included in the stripe area and storing the parity in the remaining one strip area, and forming a redundant configuration of RAID 5 in which the storage device for storing the parity is changed for every address;
a cache area placement unit for, when receiving a write request from the upper-level device, placing in the cache memory a cache area comprising a plurality of page areas having the same size as the stripe area; and
a write-back processing unit for, when new data in the cache memory which is newer than the data in the storage device is to be written back to the storage device, generating new parity data by use of an unused area in the cache area, and then, writing the new data and the new parity to the corresponding storage devices.

2. The storage system according to claim 1 that, if the new data is present in one of the plurality of page areas constituting the cache area, the write-back processing unit reads out old data and old parity from the storage devices corresponding to the new data by use of an unused page area as a work area, then, generates new parity from the new data, the old data, and the old parity, and writes the new data and the new parity to the corresponding storage devices.

3. The storage system according to claim 1 that, if the new data is present in all of the page areas except for the parity-corresponding area of the plurality of page areas constituting the cache area, the write-back processing unit generates new parity from the plurality of new data by use of an unused page area as a work area, and writes the new data and the new parity to the corresponding storage devices.

4. The storage system according to claim 1 that, if the new data is present in all of the page areas except for the parity-corresponding area of the plurality of page areas constituting the cache area and space is present in a part of the new data in the page areas, the write-back processing unit reads out old data from the storage device corresponding to the part of the space in the page areas and stores it, then, generates new parity from the plurality of new data by use of an unused page area as a work area, and writes the new data and the new parity to the corresponding storage devices.

5. The storage system according to claim 1 that the cache area placement unit releases, when write by the write-back processing unit is completed, the corresponding cache area.

6. A control method of a storage system comprising
a cache control step of managing data in a cache memory in a page area unit, and processing an input/output request from an upper-level device to a storage device;
a RAID control step of managing data in each of a plurality of the storage devices in a strip area unit having the same size as the page area and managing a plurality of strip areas having the same address collectively in a stripe area unit, generating parity from data in the plurality of strip areas, except for one strip area, included in the stripe area and storing the parity in the remaining one strip area, and forming a redundant configuration of RAID 5 in which the storage device for storing the parity is changed for every address;
a cache area placement step of, when receiving a write request from the upper-level device, placing in the cache memory a cache area comprising a plurality of page areas having the same size as the stripe area; and
a write-back processing step of, when new data in the cache memory which is newer than the data in the storage device is to be written back to the storage device, generating new parity data by use of an unused area in the cache area, and then, writing the new data and the new parity to the corresponding storage devices.

7. The control method of a storage system according to claim 6 that, if the new data is present in one of the plurality of page areas constituting the cache area, in the write-back processing step, old data and old parity is read out from the storage devices corresponding to the new data by use of an unused page area as a work area, then, new parity is generated from the new data, the old data, and the old parity, and the new data and the new parity is written to the corresponding storage devices.

8. The control method of a storage system according to claim 6 that, if the new data is present in all of the page areas except for the parity-corresponding area of the plurality of page areas constituting the cache area, in the write-back processing step, new parity is generated from the plurality of new data by use of an unused page area as a work area, and the new data and the new parity is written to the corresponding storage devices.

9. The control method of a storage system according to claim 6 that, if the new data is present in all of the page areas except for the parity-corresponding area of the plurality of page areas constituting the cache area and space is present in a part of the new data in the page areas, in the write-back processing step, old data is read out from the storage device corresponding to the space in the page areas and stored, then, new parity is generated from the plurality of new data by use of an unused page area as a work area, and the new data and the new parity is written to the corresponding storage devices.

10. The control method of a storage system according to claim 6 that, in the cache area placement step, when write by the write-back processing step is completed, the corresponding cache area is released.

11. A program for controlling a storage system, wherein said program allows a computer to execute:
a cache control step of managing data in a cache memory in a page area unit, and processing an input/output request from an upper-level device to a storage device;
a RAID control step of managing data in each of a plurality of the storage devices in a strip area unit having the same size as the page area and managing a plurality of strip areas having the same address collectively in a stripe area unit, generating parity from data in the plurality of strip areas, except for one strip area, included in the stripe area and storing the parity in the remaining one strip area, and forming a redundant configuration of RAID 5 in which the storage device for storing the parity is changed for every address;
a cache area placement step of, when receiving a write request from the upper-level device, placing in the cache memory a cache area comprising a plurality of page areas having the same size as the stripe area; and
a write-back processing step of, when new data in the cache memory which is newer than the data in the storage device is to be written back to the storage device, generating new parity data by use of an unused area in the cache area, and then, writing the new data and the new parity to the corresponding storage devices.

12. The program according to claim 11 that, if the new data is present in one of the plurality of page areas constituting the cache area, in the write-back processing step, old data and old parity is read out from the storage devices corresponding to the new data by use of an unused page area as a work area, then, new parity is generated from the new data, the old data, and the old parity, and the new data and the new parity is written to the corresponding storage devices.

13. The program according to claim 11 that, if the new data is present in all of the page areas except for the parity-corresponding area of the plurality of page areas constituting the cache area, in the write-back processing step, new parity is generated from the plurality of new data by use of an unused page area as a work area, and the new data and the new parity is written to the corresponding storage devices.

14. The program according to claim 11 that, if the new data is present in all of the page areas except for the parity-corresponding area of the plurality of page areas constituting the cache area and space is present in a part of the new data in the page areas, in the write-back processing step, old data is read out from the storage device corresponding to the space in the page areas and stored, then, new parity is generated from the plurality of new data by use of an unused page area as a work area, and the new data and the new parity is written to the corresponding storage devices.

15. The program according to claim 11 that, in the cache area placement step, when write by the write-back processing step is completed, the corresponding cache area is released.
